(19) United States
(12) Patent Application Publication
(10) Pub. No.: US 2012/0024863 A1
(43) Pub. Date: Feb. 2, 2012

(54) Multiple compartment container

(76) Inventor: Yong Hoon Cho, Fullerton, CA (US)

(21) Appl. No.: 12/804,677

(22) Filed: Jul. 27, 2010

(51) Int. Cl. B65D 25/04; B29C 49/20; B65D 51/00

(52) U.S. Cl. 220/506; 220/524; 264/537

(57) ABSTRACT

A multiple compartment container having a plurality of independent double compartment containers within a container. Each double compartment container have an outer larger compartment fully enclosing an inner smaller compartment with each adjacent compartment having an independent open end located opposite each other to allow free accessibility to the compartment. Each open end accommodates a closure device to close the compartments. This prevents the contents of one compartment from mixing with the contents of the other compartment.

This invention relates to a multiple compartment container having a closure located on opposite side of the compartments for easier access.

### BACKGROUND

Most multiple compartment containers have a side by side division as disclosed by U.S. Pat. Nos. 5,135,702 and 4,196,808 and US Patent Applications 2002/0094224 and 2002/0030063. Others have compartments with a common closure such as US Patent Applications 2009/0014449 and U.S. Pat. No. 6,276,853. None of these have a smaller compartment fully enclosed by a larger compartment with each compartment having an independent closure or closure device located opposite each other. Closure and closure device are interchangeably used herein. The advantage of the latter is its compactness, the ease of accessibility with one closure not getting into the way of the other and the ability of placing different types of items on each compartment as well as placing different colored closure for easy identification of the contents or different types of closure for different contents and applications. A double compartment container has a large number of usage that are too numerous to enumerate. This container can hold liquids of different densities and solid materials of different particle sizes. A combination of solids and liquids is also possible, the solid in one compartment and the liquid in the other. This container's usage is expanded by having the ability to cap the compartments with different types of closure and/or dispensers. Here are a few examples from a milieu of applications for this type of container. In the cosmetic industry, just mentioning one example, one container can be used for a nail polish having a closure with a brush applicator while the other container can hold a nail polish remover with a plain screw cap if one will use an external absorbent material to apply the remover to the nails or the cap for the remover can have an applicator with a sponged tip. In the medical and pharmaceutical field, it is advantageous to be able to hold two different liquid medications or carry a formulation for medical usage where the solid powder that needs reconstitution is in one compartment while the reconstituting liquid is in the other compartment. For infant use, for example, it can serve as a baby bottle having feeding nipples on each compartment at opposite side from each other, one compartment for milk and the other for juice; water on one and juice in the other, milk on one and water on the other, etc; Other usage can employ a pump dispenser, the pump dispenser can have an additional over cap either to cover the dispenser or make it able to lay the container upright; it can have snap closures like those used for condiments to have catsup on one compartment and mustard on the other; the cap can have an inner intermediate closure with multiple perforations for dispensing solids, the size of the perforations depending on the particle size of the solid to be contained. In summary, the application for this type of container is so numerous, limited only by the types of closure that can be used and as new closures get developed, the applications for this type of containers also increases. To have more than two compartments, one has to simply expand the number of double compartment containers described herein by adhering a common lateral side between two double compartment containers and maintaining opposite open ends on any adjacent compartment to form multiple compartment containers. It is important for the closure device on the open end of any two adjacent compartments, to be opposite each other to maintain easy accessibility to the desired compartment which is an important feature of this invention.

It is therefore an object of this invention to provide a double compartment container having closures at opposite location.

It is also an object of this invention to provide a multiple compartment container that can be used in different applications by simply employing a different closure device.

It is still an object of this invention to provide a multiple compartment container having an independent inner compartment of a smaller size with its own closure and an independent larger outer compartment with its own closure.

It is also a further object of this invention to provide a multiple compartment container that is compact with easily accessible compartments.

### SUMMARY

A multiple compartment container, herein comprise a plurality of independent double compartment containers within a container. Each double compartment container have an outer larger compartment fully enclosing an inner smaller compartment with each adjacent compartment having an independent open end located opposite each other to allow free accessibility to the compartment. Each open end accommodates a closure device to close the compartments. This design prevents the contents of one compartment from mixing with the contents of the other compartment. The compartment can have an intermediate lid between the open end of the compartment and the closure device. The intermediate lid may be perforated with one or more perforations. The size of the perforations depend upon the type of solid or liquid stored inside the compartment. The compartments can hold either a solid or liquid content or material. The compartments can be closed by different types of closure devices which defines the usage of the compartment of the container. An over cap can be used to cover the closure device. The closure device of the same type of closure can be colored differently for differentiation or easy identification of the contents of the compartments. The shape of the compartments may be the same or they may be different. The size of the compartments and consequently, the container can also vary.

A method for preparing a double compartment container described above comprises preparing a semi-molten first injection product having a shape conforming to the shape of a neck opening of the outer larger compartment using an injection molding process on a first mold; transferring the semi-molten first injection product from the first injection mold to a top portion of a second mold which is an injection blow mold; introducing air at a defined pressure and temperature for a defined time to a hollow portion of the semi-molten first injection product to allow the semi-molten product to take on the shape and line against all inner walls of the injection blow mold to form the outer larger compartment of the container; preparing a neck opening for the inner smaller compartment using an injection molding process on a third mold; and, adhering the neck opening of the inner smaller compartment at a bottom portion of the outer larger compartment to form the inner smaller compartment. A multiple compartment container is formed by adhering a common lateral side between two double compartment containers and maintaining opposite open ends on any adjacent compartment.

### BRIEF DESCRIPTION OF THE DRAWING

Aspects of the present invention are illustrated by way of example, and not by way of limitation, in the accompanying drawings, wherein:

FIG. 1 is a perspective view of the multiple compartment container.

FIG. 2A is a perspective view of the multiple compartment container showing an intermediate lid member and a screw cap.

FIG. 2B are perspective views of examples of closures that can be used with the multiple compartment container based on its usage.

FIG. 2C is a perspective view of the multiple compartment container having a pump dispenser further covered with an over cap.

FIG. 3 is a perspective view of a multiple compartment container having an inner and outer container of a different shape than the one shown on FIG. 1.

FIGS. 3A and 3B are perspective views of a multiple compartment container shown in FIG. 3 with different sizes of the inner compartment.

FIG. 4 is a perspective view of a multiple compartment container having an outer compartment of a different shape than the inner compartment.

FIG. 5 is a schematic for a method used in making a double compartment container.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any multiple compartment container having the described features or shown in the drawings or are obvious modifications that can be derived from reading the description are within the scope of this invention. The detailed description includes specific details to provide a thorough understanding of the claimed invention and it is apparent to those skilled in the art that the claimed invention may be practiced without these specific details. In some instances, well known structures and devices may be shown in block diagrams or drawn with broken lines in order to either avoid obscuring the main concepts of the invention or to show the relationship of one part to the other.

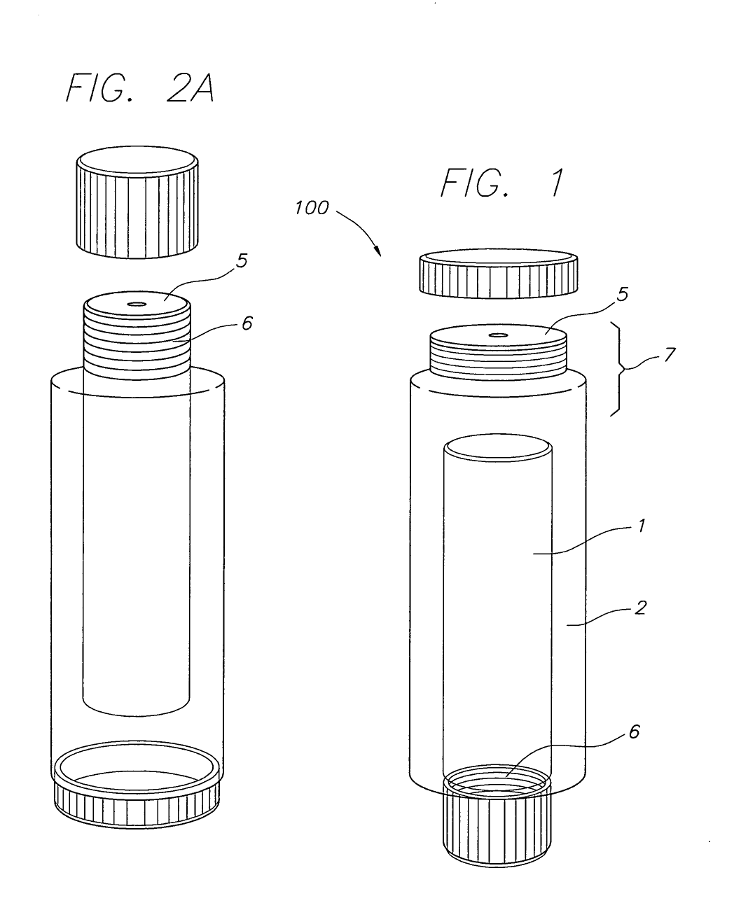

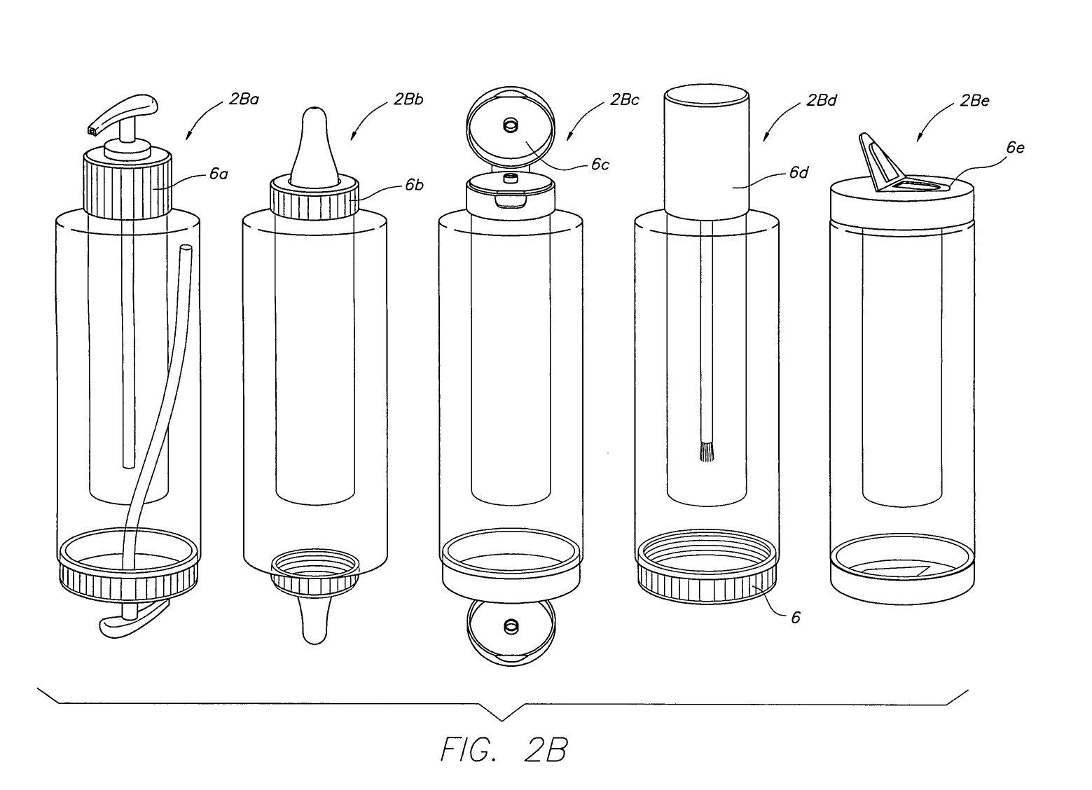

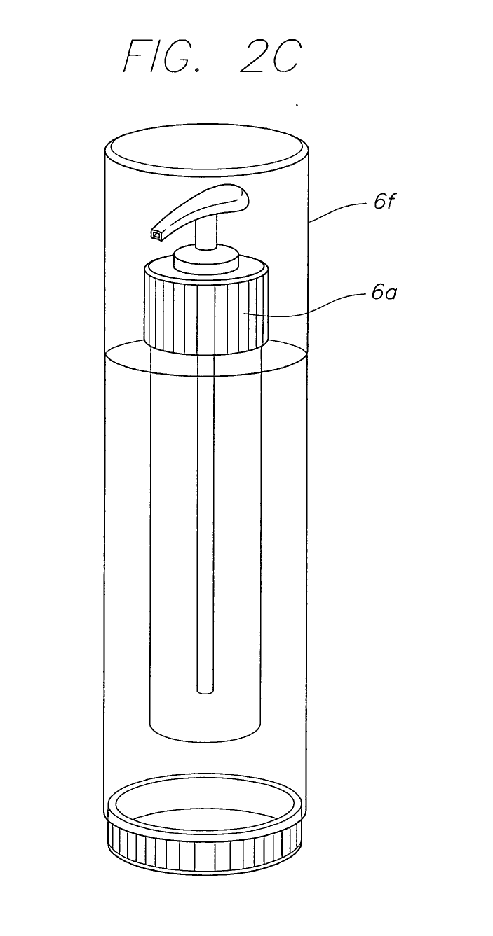

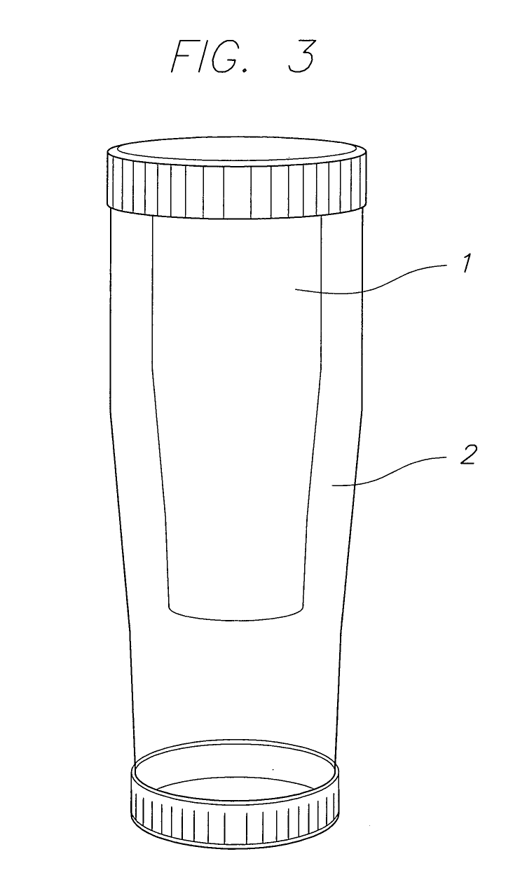

FIG. 1 shows a perspective view of the multiple compartment container 100, more specifically having a smaller inner compartment 1 enclosed within a larger outer compartment 2. The inner compartment is open at one end 3 opposite the open end 4 of the outer compartment. The opening of the compartments can have an optional intermediate lid member 5 between the open ends and the closure device. This may be perforated with one hole to a number of holes of a desired diameter to act as a sieve for solid particles such as spices or to control the flow of liquids. The inner compartment 1 is independent of the outer compartment 2 such that contents of the inner compartment will not leak into or mix with the contents of the outer compartment 2. This container 100 can be used for solids and liquids. General usage container 100 will usually employ a screw cap closure 6 as shown in FIG. 1 and FIG. 2A to close the open ends 3 and 4. Using a different colored closure device for each compartment with the same type of closure devices can be one form of identifying the contents of the compartment. Putting an intermediate lid member 5 or different types of closure devices on the compartments cater this container 100 to a variety of different specific usages. Examples of different closures or closure devices are shown in FIG. 2B. It includes but is not limited to pump dispenser 6a as shown in 2Ba, nipple 6b as shown in 2Bb, snap caps 6c as shown in 2Bc, caps with brush applicators 6d as shown in 2Bd, spout 6e as shown in 2Be, etc. The compartments need not have the same type of closures but one compartment may have a different closure than the other as shown in FIG. 2Bd where one closure is a cap with a brush applicator 6d while the other is a screw cap 6. The closure devices may in itself function to cover the compartment or have an additional external or over cap to cover the closure device. Other mechanisms to close the compartment completely and prevent leakage are known and can be applied to the open ends 3 and 4. To allow the container to lay upright on a surface, some closure for example, may require another cap as shown by the over cap 6f. FIG. 2C shows a multiple container with a pump dispenser 6a and an outside cap 6f, usually a type of snap cap, with an external top flat surface to allow the bottle to lay upright. It is recommended to have the cap's lateral surface align with the lateral surface of the container to achieve a better balance and prevent the container from tipping over.

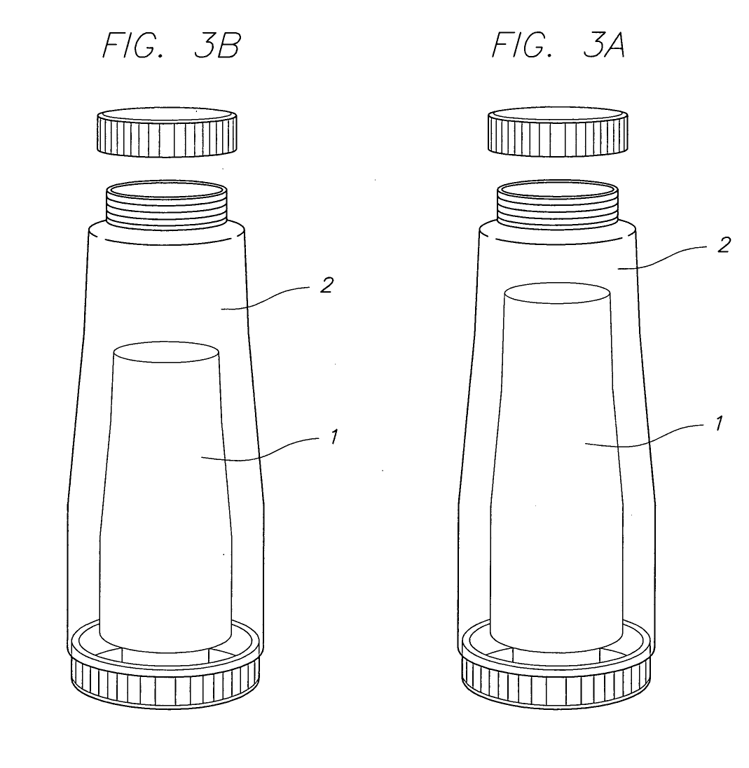

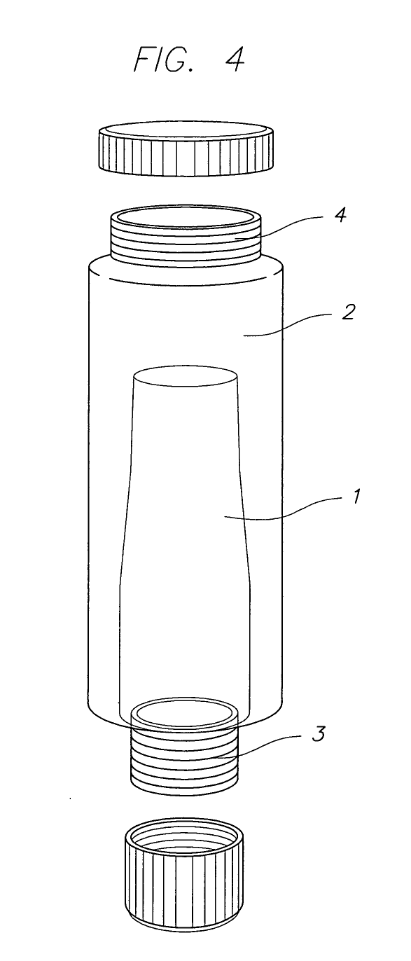

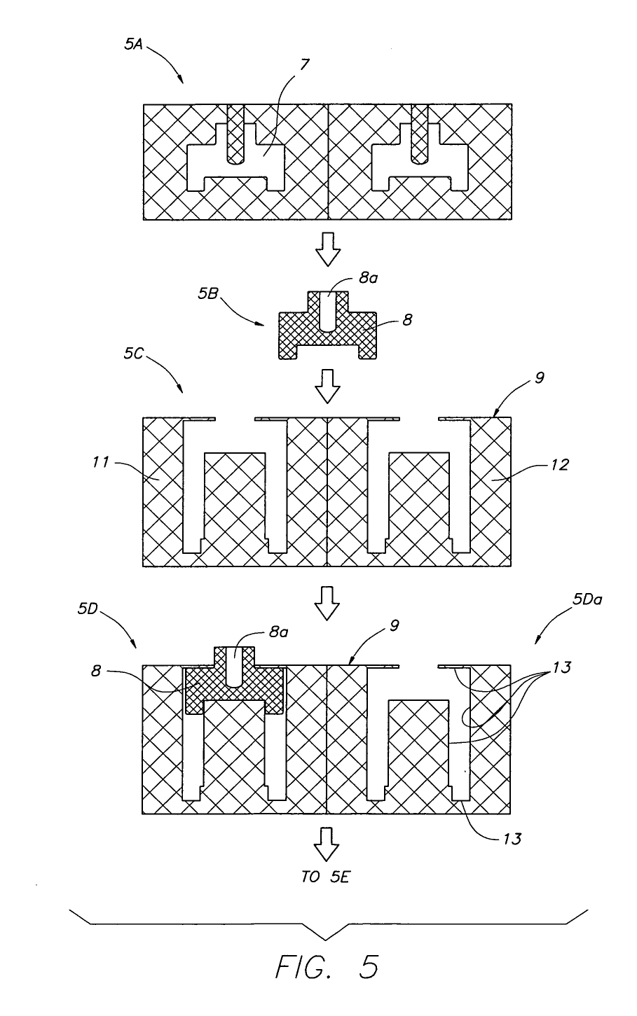

FIG. 1 shows two cylindrical concentric compartments. However, the outer and inner compartments can have a variety of shapes too numerous to enumerate. FIG. 3 shows a tapering outer compartment with another tapering inner compartment. The height of the inner compartment in relation to the outer compartment can also vary. FIG. 3A shows an inner compartment taller than the inner compartment shown on FIG. 3B. The shape of the inner compartment can vary from the shape of the outer compartment or vice versa so long as there is sufficient room to accommodate each other and allow their respective contents to freely flow in and out of the container. For example, as shown in FIG. 4, the inner tapered compartment of FIG. 3A can be inside the outer cylindrical compartment shown in FIG. 1. The size of the compartments and consequently, the size of the container can vary depending upon the volume of the contents to be held or stored in the container.

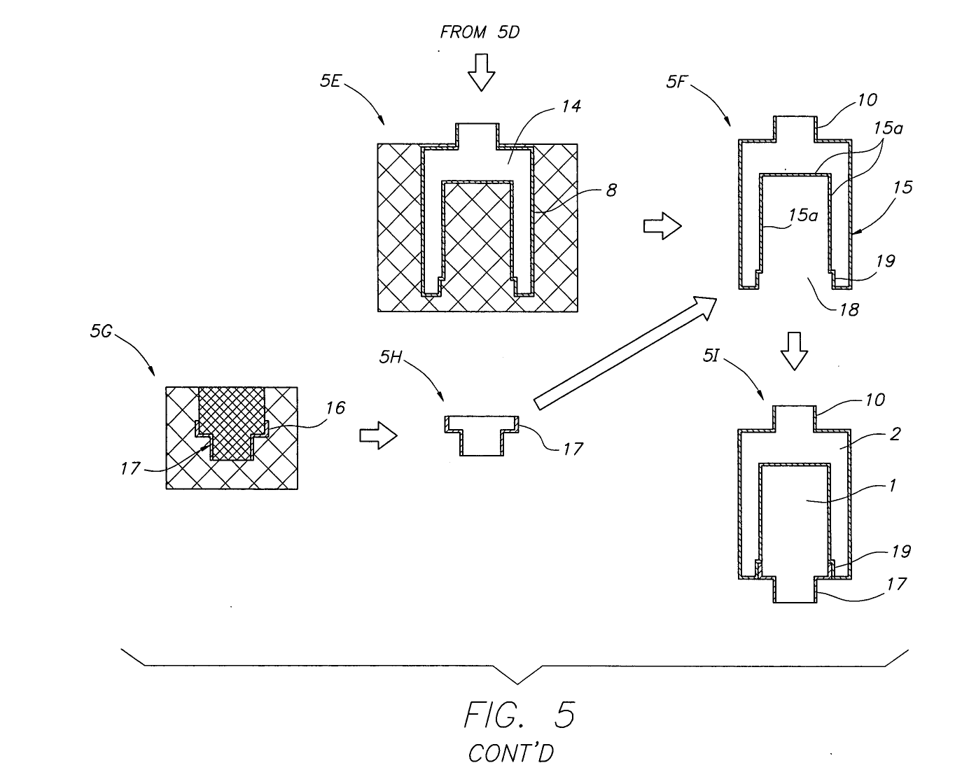

A bottle manufacturer can device ways of making this multiple compartment container as soon as they see the picture of the claimed container. FIG. 5 shows an example of a method for making a plastic double compartment container 100 having independent concentric cylindrical compartments shown in FIG. 1. The process conditions stated here are just examples as each process condition differs according to the raw material used as well as the dimensions of the container. Almost all resins used for preparing thermosetting plastic bottles can be used such as Acrylonitrile Butadiene Styrene (ABS), Polyethylene Terephthalate (PET), Polyamide, Polycarbonate, Polyvinylchloride (PVC), Low-density polyethylene (LDPE), High-density polyethylene (HDPE), Ultra high molecular weight (UHMW-PE), Polypropylene, Ionomar, and Poly-4-methyl-1-pantene (TPX). The raw material for preparing the outer container is first prepared in a first mold shown in 5A. The mold consists of a male and female member that is shaped to achieve a desired contour conforming with the shape of the inner walls of a neck portion 7 of the outside compartment shown in FIG. 1. This shape varies according to the shape of the outer compartment of the container. The material is introduced from a hopper and is heated at 200-250° C. prior to being injected into the mold through an injection nozzle. The injection conditions differ according to the starting raw material used but generally, the nozzle temperature is 200-250° C., the injection pressure is at 700-1000 kg/cu. cm., the injection time is 20-30 seconds and the mold temperature is at 40-60° C. The semi-molten first injection product 8 shown in 5B, which is around 50° C. is quickly transferred to a second mold 9 which is an injection blow mold shown in 5C. Air is introduced at the unhatched or unshaded hollow clear portion 8a of the injection product 8 where the top neck opening 10 is formed. The injection blow mold 9 also referred to herein as second mold, also has a left male 11 and a right female member 12. The first injection product 8 is positioned at the top portion of either the male or the female member before the second mold is closed as shown in 5D. While the first injection product 8 is semi-molten, after closure of the second mold, air at temperatures of 140-200° C. is introduced at the hollow clear portion 8a of the injection product 8 at a pressure of 10-18 kg/cc for about 20-30 seconds to allow the molten product 8 to take on the shape and line the first injection product against the inner wall 13 of the second mold, leaving a hollow interior 14 as shown in 5E. The inner wall 13 of the second mold without the first injection product is shown in 5Da. The temperature, pressure and duration of the injection vary with the material used. The information provided here are just examples. The shape of the mold for the first injection product 8 depend upon the shape of the second mold 9 where the first injection product is introduced. The second mold 9 defines the outside contour of the outer compartment 2. The product from the second mold 15 is allowed to solidify before removal from the mold. The finish product 15 from the second mold as shown in 5F is the outer compartment 2 including its top neck opening 10. The interior central walls 15a of the outer compartment 2 form the walls of the inner compartment 1. A third mold 16 shown in 5G which is an injection mold like the first mold is used for making the neck opening 17 of the inner compartment 1. The conditions for preparing the neck opening are the same as that used for preparing the first injection product. After the neck opening 17 has been formed as shown in 5H, it is introduced at the bottom portion 18 of the outer compartment 2 resulting in a neck opening for the inner compartment 1. The neck opening 17 of the inner compartment is sealed to the bottom central wall 19 of the outer compartment 2 by an ultrasonic attacher to securely fit into the bottom central wall 19 of the outer compartment as shown in 5I. The neck openings 10 and 17 formed from the first mold and the third mold, respectively, due to the design of the mold used, will have an outer wall conforming with the contour of the closure to be used, for example, a screw etching for a screw cap.

Closure devices such as those shown in FIG. 2B are introduced into the respective neck openings 10 and 17 to close both compartments.

While the embodiments of the present invention have been described, it should be understood that various changes, adaptations, and modifications may be made therein without departing from the spirit of the invention and the scope of the claims.

I claim:

1. A multiple compartment container, comprising:
a plurality of independent double compartment containers within a container, each double compartment container having an outer larger compartment fully enclosing an inner smaller compartment, each adjacent compartment having an independent open end located opposite each other to allow free accessibility to the compartment, the open ends accommodating closure devices to close the compartments.

2. A double compartment container, comprising:
an outer larger compartment fully enclosing an inner smaller compartment, each compartment independent of each other having its own independent open end accommodating a closure device thereby preventing contents of one compartment from mixing with contents of the other compartment, the open end of one compartment located opposite the open end of the other compartment to allow free accessibility to the compartments.

3. The double compartment of claim 2 further comprising an intermediate lid between the open end of the compartment and the closure device.

4. The double compartment of claim 3 wherein the intermediate lid is perforated.

5. The double compartment of claim 4 wherein the intermediate lid has one or more perforations.

6. The double compartment of claim 4 wherein the size of the perforations depend upon the type of solid or liquid inside the compartment.

7. The double compartment of claim 2 wherein the compartments hold solid or liquid contents.

8. The double compartment of claim 2 wherein the open end is closed by different types of closure devices, the type of closure defining the usage of the compartment of the container.

9. The double compartment of claim 8 further comprising an over cap covering the closure device.

10. The double compartment of claim 2 wherein the open end is closed by different colored closure devices for the same type of closure to easily differentiate or identify the contents of the compartment.

11. The double compartment of claim 2 wherein the shape of the compartments is the same.

12. The double compartment of claim 2 wherein the shape of the compartments differs from each other.

13. The double compartment of claim 2 wherein the size of the compartments or the container is different depending upon the volume of contents to be held or stored.

14. A method for preparing a double compartment container having an outer larger compartment fully enclosing an inner smaller compartment, each compartment independent of each other having an open end located opposite each other to allow free accessibility to the compartment, comprising:
preparing a semi-molten first injection product having a shape conforming to the shape of a neck opening of the outer larger compartment using an injection molding process on a first mold;
transferring the semi-molten first injection product from the first injection mold to a top portion of a second mold, an injection blow mold;
introducing air at a defined pressure and temperature for a defined time to a hollow portion of the semi-molten first injection product to allow the semi-molten product to take on the shape and line against all inner walls of the injection blow mold to form the outer larger compartment of the container;
preparing a neck opening for the inner smaller compartment using an injection molding process on a third mold; and,
adhering the neck opening of the inner smaller compartment at a bottom portion of the outer larger compartment to form the inner smaller compartment.

15. The method of claim 14 further comprising adhering a common lateral side between two double compartment container and maintaining opposite open ends on any adjacent compartment to form multiple compartment containers.

16. The method of claim 14 wherein the injection molding process conditions for the first and third molds are an injection pressure of 700-1000 kg/cu.cm., a nozzle temperature of 40-60° C. with an injection time of 20-30 seconds.

17. The method of claim 14 wherein air is introduced at temperatures of 140-200° C. and pressures of 10-18 kg/cc for about 20-30 seconds.

18. The method of claim 14 wherein the neck opening of the inner smaller compartment is adhered to the outer larger compartment by an ultrasonic attacher.

19. The method of claim 14 wherein the first injection product is kept at about 50° C. when air is introduced at its hollow portion on the second mold.
